(19) United States
(12) Patent Application Publication
(10) Pub. No.: US 2003/0229425 A1
(43) Pub. Date: Dec. 11, 2003

(54) AN AUTONOMOUS AGRICULTURAL MACHINE FOR PERFORMING AN AGRICULTURAL OPERATION, IN PARTICULAR CROP PROCESSING

(75) Inventor: Theo Jan MIEDEMA, De Lier (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, Zug (CH)

(21) Appl. No.: 10/250,121

(22) Filed: Jun. 5, 2003

(30) Foreign Application Priority Data
Jun. 6, 2002 (NL) 1020798

(51) Int. Cl. G05D 1/00

(52) U.S. Cl. 701/1

(57) ABSTRACT

An autonomous agricultural machine for performing an agricultural operation, in particular crop processing. The agricultural machine is autonomously displaceable over an agricultural parcel. The agricultural machine is provided with a drive and with a movable agricultural device for performing the agricultural operation. The agricultural machine is provided with a protecting element for protecting the moving agricultural device, with a displacement-detector for detecting displacement of the agricultural machine and for emitting a displacement signal, and with an operating device for operating the protecting element in dependence on the displacement signal.

### CROSS REFERENCE TO RELATED APPLICATIONS

This application claims priority from Dutch patent application no. 1020798 filed Jun. 6, 2002, the contents of which are hereby incorporated by reference in their entirety.

### BACKGROUND OF INVENTION

1. Field of the Invention

The invention relates to the field of agriculture and to an autonomous agricultural machine for performing an agricultural operation, in particular crop processing.

2. DESCRIPTION OF THE RELATED ART

A drawback of generally known agricultural machines is that the driver of the agricultural machine is principally responsible for the safety of the environment, in particular the safety of human beings and animals. When observing danger for the safety of the environment, the driver should activate, on the one hand, an emergency stop that stops the agricultural operation and should operate, on the other hand, the brakes of the agricultural machine so as to prevent damage or injury. Moreover, each time before putting the agricultural machine into operation, a driver should verify whether somebody or something has crept into or has somehow got into the agricultural machine.

### SUMMARY OF INVENTION

According to the present invention there is provided an autonomous agricultural machine for performing an agricultural operation, in particular crop processing comprising an improved safety-system.

For this purpose, according to the invention an autonomous agricultural machine is disclosed for performing an agricultural operation, in particular crop processing. The agricultural machine is autonomously displaceable over an agricultural parcel and comprises a drive, a movable agricultural device for performing the agricultural operation, a displacement-detector for detecting a displacement of the agricultural machine and for emitting a displacement signal and an operating device for operating the protecting element in response to the displacement signal. The protecting element is automatically operated in response to the displacement signal, which improves safety.

Although the displacement-detector may be a separate detector, it is advantageous if the displacement-detector comprises the drive of the agricultural machine. This makes it possible that, when the drive of the agricultural machine is activated, the displacement signal is emitted at the same time. It is pointed out here that in many cases the drive for displacing the agricultural machine is also used for moving the agricultural device.

In a safe embodiment of an agricultural machine according to the invention, the operating device is suitable for bringing the protecting element into an active position in which the protecting element protects the movable agricultural device if the displacement signal indicates that the agricultural machine is not moving, and is suitable for bringing the protecting element into an inactive position in which the protecting element releases the movable agricultural device if the displacement signal indicates that the agricultural machine is moving.

The operating device is preferably an electronic operating device. As an alternative, the operating device may be a hydraulic operating device.

According to the present invention there is also disclosed a method of protecting a movable agricultural device on an autonomous agricultural machine for performing an agricultural operation, in particular crop processing, the agricultural machine being autonomously displaceable over an agricultural parcel, comprising: providing a protecting element in a first position for protecting the movable agricultural device when the agricultural machine is not moving; detecting a displacement of the agricultural machine and emitting a displacement signal; and operating the protecting element in response to the displacement signal, to a second position for exposing the movable agricultural device.

### BRIEF DESCRIPTION OF DRAWINGS

An embodiment of the invention will now be explained in further detail by way of example only with reference to the accompanying figures, in which:

FIG. 1 shows schematically in side view an autonomous agricultural machine in an embodiment of the invention, and

FIG. 2 is an embodiment of an operating device for operating a protecting element of an autonomous agricultural machine as shown in FIG. 1.

### DETAILED DESCRIPTION

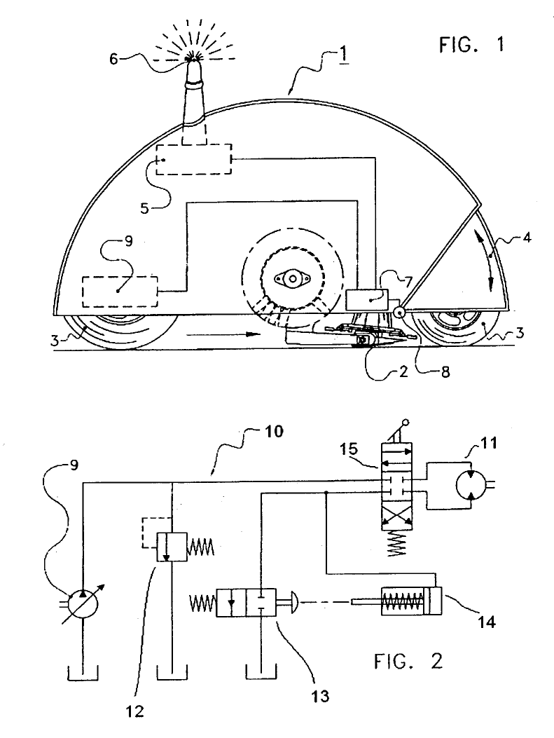

FIG. 1 shows schematically in side view an autonomous agricultural machine 1 in an embodiment of the invention. It is pointed out here that an autonomous machine, i.e. a machine that does not require a driver for being moved, but moves with the aid of inter alia a position-determining system, is known per se and will not be set out here in further detail for the sake of simplicity of the description. Such an autonomous machine may for instance be of the type described in U.S. Pat. No. 4,769,700 the contents of which are hereby incorporated by reference in their entirety. Various aspects of an autonomous machine are disclosed in co-pending U.S. patent application Ser. No. ______ â [symbol] â entitled “An Agricultural Machine for Performing an Agricultural Operation”; Ser. No. ______ â [symbol] â entitled “An Agricultural Machine for Performing Crop Processing”; Ser. No. ______ â [symbol] â entitled “A Device for Crop Processing” Ser. No. ______ â [symbol] â entitled “An Assembly for Performing Crop Harvesting” Ser. No. ______ â [symbol] â entitled “A System for and a Method of Performing a First and a Second Agricultural Operation on an Agricultural Parcel” Ser. No. ______ â [symbol] â entitled “An Assembly for Performing an Agricultural Operation, in Particular Crop Processing” Ser. No. ______ â [symbol] â entitled “An Agricultural Machine for Performing an Agricultural Operation, in Particular Crop Processing”and Ser. No. ______ â [symbol] â entitled “An Assembly and an autonomous agricultural machine for performing an agricultural operation, in Particular Crop Processing”, all of which claim priority in the Netherlands on Jun. 6, 2002. The contents of all of these applications are hereby incorporated by reference in their entirety.

The autonomous agricultural machine 1 is suitable for performing an agricultural operation, in particular crop processing, on a crop that is present on an agricultural parcel. In the embodiment shown the autonomous agricultural machine 1 is an autonomous mowing machine that mows crop that is present on the agricultural parcel by means of a mowing unit 2. Although several sorts of mowing units known per se may be used, in the embodiment shown the mowing unit 2 is constituted by mowing discs that are present on a cutter bar and are rotatable about an axis, which mowing discs are provided with mowing knives. It will be obvious that the agricultural machine may also be an agricultural machine for performing other crop-processing operations.

The agricultural machine 1 is supported and displaced over the agricultural parcel by means of wheels 3. The autonomous agricultural machine 1 further comprises a mechanical protecting element 4, in the embodiment shown constituted by a cap, for protecting the movable agricultural device, in the embodiment shown the mowing unit 2.

The agricultural machine 1 further comprises a position-determining element 5 known per se, in the embodiment shown provided with an aerial 6, for determining the position of the autonomous agricultural machine 1 in the agricultural parcel by means of for example a GPS-system. Said position-determining element 5 may also be used as displacement-detector for detecting displacement of the agricultural machine 1. Depending on the detected displacement, the position-determining element 5 emits a displacement signal to an operating device 7 for operating, in dependence on the displacement signal, the protecting element 4. Operating may result for example in rotation of the cap 4 about an axis of rotation 8. In this case the operating device 7 is preferably an electronic operating device.

Although the protective cap 4 may be brought into the position in which it protects the mowing unit 2 when the displacing speed of the agricultural machine 1 comes below a predetermined magnitude, from a point of view of safety, in the embodiment shown the protecting element 4 is brought by the operating device 7 into the active position in which the protecting element 4 protects the movable agricultural device 2 if the displacement signal indicates that the agricultural machine 1 is not moving, and the protecting element 4 is brought by the operating device 7 into the inactive position in which the protecting element 4 releases the movable agricultural device 2 if the displacement signal indicates that the agricultural machine 1 is moving.

FIG. 2 shows an exemplary embodiment of a hydraulic scheme for actuating the protecting element 4. In the embodiment shown in FIG. 2 the displacement-detector comprises the drive 9 of the agricultural machine 1. The hydraulic circuit also includes a hydraulic operating device 11 for controlling the movement of the protecting element 4. A control valve 12 controls operation of the mowing unit 2 and a master control valve 13 for the hydraulic circuit is connected to an actuator 14 which actuates a protecting element control valve 15. When the drive 9 is energized, not only the wheels 3 are driven, but the mowing unit 2 is also set in motion via the control valve 12 and at the same time the protecting element 4 is brought into the inactive position by the hydraulic operating device 11. When the drive of the wheels 3 is stopped, then, at the same time, the protecting element 4 is brought into the active (protective) position and the drive of the mowing unit 2 is stopped.

It will be obvious that the invention is not limited to the above-described embodiments. The mechanical protecting element may for example comprise other means such as a box, a hatch, a canvas, a rolling door, an airbag or the like. Checking means may further be applied for checking the correct functioning of the mechanical detecting element.

Many modifications in addition to those described above may be made to the structures and techniques described herein without departing from the spirit and scope of the invention. In particular, the devices and methods disclosed herein may also be used in conjunction with further features of the above-referenced co-pending applications. Accordingly, although specific embodiments have been described, these are examples only and are not limiting upon the scope of the invention. Accordingly, although specific embodiments have been described, these are examples only and are not limiting upon the scope of the invention.

1. An autonomous agricultural machine for performing an agricultural operation, in particular crop processing, the agricultural machine being autonomously displaceable over an agricultural parcel, the agricultural machine comprising:
a drive;
a movable agricultural device for performing the agricultural operation;
a protecting element for protecting the movable agricultural device;
a displacement-detector for detecting a displacement of the agricultural machine and for emitting a displacement signal; and
an operating device for operating the protecting element in response to the displacement signal.

2. The autonomous-agricultural machine as claimed in claim 1, wherein the displacement-detector comprises the drive of the agricultural machine.

3. The autonomous agricultural machine as claimed in claim 1, wherein the operating device brings the protecting element into an active position in which the protecting element protects the movable agricultural device if the displacement signal indicates that the agricultural machine is not moving, and wherein the operating device brings the protecting element into an inactive position in which the protecting element releases the movable agricultural device if the displacement signal indicates that the agricultural machine is moving.

4. The autonomous agricultural machine as claimed in claim 1, wherein the operating device is an electronic operating device.

5. The autonomous agricultural machine as claimed in claim 1, wherein the operating device is a hydraulic operating device.

6. The autonomous agricultural machine as claimed in claim 2, wherein the operating device brings the protecting element into an active position in which the protecting element protects the movable agricultural device if the displacement signal indicates that the agricultural machine is not moving, and wherein the operating device brings the protecting element into an inactive position in which the protecting element releases the movable agricultural device if the displacement signal indicates that the agricultural machine is moving.

7. The autonomous agricultural machine as claimed in claim 2, wherein the operating device is an electronic operating device.

8. The autonomous agricultural machine as claimed in claim 2, wherein the operating device is a hydraulic operating device.

9. The autonomous agricultural machine as claimed in claim 3, wherein the operating device is an electronic operating device.

10. The autonomous agricultural machine as claimed in claim 3, wherein the operating device is a hydraulic operating device.

11. The autonomous agricultural machine as claimed in claim 1, wherein the movable agricultural device is a mower.

12. An autonomous agricultural machine for performing an agricultural operation comprising:
a drive;
a movable agricultural device for performing the agricultural operation;
a protecting element for protecting the movable agricultural device;
a displacement-detector for detecting a displacement speed of the agricultural machine and for emitting a speed signal; and
an operating device for bringing the protecting element into an active position in which the protecting element protects the movable agricultural device if the speed signal indicates that the agricultural machine moving slower than a given value, and wherein the operating device brings the protecting element into an inactive position in which the protecting element releases the movable agricultural device if the displacement signal indicates that the agricultural machine is moving faster than a given value.

13. A method of protecting a movable agricultural device on an autonomous agricultural machine for performing an agricultural operation, the agricultural machine being autonomously displaceable over an agricultural parcel, the method comprising:
providing a protecting element in a first position for protecting the movable agricultural device when the agricultural machine is not moving;
detecting a displacement of the agricultural machine and emitting a displacement signal; and
operating the protecting element in response to the displacement signal, to a second position for exposing the movable agricultural device.

14. The method as claimed in claim 13, wherein the displacement signal is emitted in response to a displacement of the agricultural machine at above a given speed.
